(19) United States
(12) Patent Application Publication
(10) Pub. No.: US 2016/0153922 A1
(43) Pub. Date: Jun. 2, 2016

(54) SYSTEM AND METHOD FOR ADAPTIVE THERMAL ANALYSIS

(71) Applicant: MediaTek Inc., Hsin-Chu (TW)

(72) Inventors: Yu-Min LEE, Hsinchu City (TW); Chi-Wen PAN, Taipei City (TW); Hung-Wen CHIOU, New Taipei City (TW); Tai-Yu CHEN, Taipei City (TW); Tao CHENG, Zhubei City (TW); Wen-Sung HSU, Zhubei City (TW); Sheng-Liang LI, Zhubei City (TW)

(21) Appl. No.: 14/951,698

(22) Filed: Nov. 25, 2015

Related U.S. Application Data
(60) Provisional application No. 62/214,516, filed on Sep. 4, 2015.
(60) Provisional application No. 62/085,266, filed on Nov. 27, 2014.

(51) Int. Cl. G01N 25/18

(52) U.S. Cl. CPC G01N 25/18

(57) ABSTRACT

A computer system and a method for adaptive thermal resistance-capacitance (RC) network analysis of a semiconductor device for use in a portable device are provided. The method includes the steps of: receiving a device input file and a plurality of specific effective heat transfer coefficients (HTCs) associated with the portable device; repeatedly performing a thermal analysis of the portable device based on the device input file and a current effective HTC to estimate a target die temperature of the semiconductor device; calculating a target effective HTC based on the device input file and the target die temperature; and updating the current effective HTC with the target effective HTC; and generating an output file recording the target die temperature of the semiconductor device.

### CROSS REFERENCE TO RELATED APPLICATIONS

This application claims the benefit of U.S. Provisional Application No. 62/085,266 filed on Nov. 27, 2014, and U.S. Provisional Application No. 62/214,516, filed on Sep. 4, 2015, the entireties of which are incorporated by reference herein.

### BACKGROUND OF THE INVENTION

1. Field of the Invention

The present invention relates to thermal simulation, and, in particular, to a system and an associated method for performing thermal resistance-capacitance (RC) network simulation of a portable device.

2. Description of the Related Art

The portable devices (smartphones and tablets) will suffer performance drop due to thermal constraint as the power of application processors (APs) increases. Unfortunately, the traditional active cooling systems such as air fan cooling and advanced microfluidic cooling are inapplicable to portable devices, which makes heat dissipation even harder. Therefore, thermal issues in handheld devices, especially for high-end smartphones, become more and more important to deal with, and an effective and efficient thermal simulator is needed to capture the thermal behaviors in the portable devices.

FIG. 8 is a diagram of the air flow in a portable device using passive cooling. For passive cooling of portable devices, the heat flow is dissipated by free convection (natural convection) and thermal radiation. Unlike active cooling, heat dissipation in portable devices is not driven by any external force. Instead, free convection is a fluid motion mechanism due to the temperature gradient. As shown in FIG. 1, the warm air with less density may rise and the cool air may replace that space. The process continues to heat the cool air, resulting in a convection flow, which takes heat away from the hot object (e.g. the portable device). The free convection is dominated by two forces: buoyancy and fluid motion in free air. Moreover, thermal radiation is energy released by the oscillation of electrons in matter; that is, the heat is dissipated by electromagnetic waves being emitted.

As a result, simulators based on thermal resistance-capacitance (RC) network technology are frequently used by IC designers to perform thermal analysis due to its simulation speed being faster than that of commercial computational fluid dynamics (CFD) tools, and thus IC designers are capable of handling thermal issues in the design phase.

Although the simulation speed of the thermal RC network is fast, some parameters strongly rely on experimental data. However, when a conventional thermal RC network simulator is applied to a different system (e.g. another portable device), the result of thermal simulation will be less accurate. In other words, the conventional thermal RC network simulator is not accurate for predicting thermal distribution in a steady state such as the temperature of a system-on-chip in a portable device.

### BRIEF SUMMARY OF THE INVENTION

A detailed description is given in the following embodiments with reference to the accompanying drawings.

In an exemplary embodiment, a method for adaptive thermal resistance-capacitance (RC) network analysis of a semiconductor device for use in a portable device is provided. The method includes the steps of: receiving a device input file and a plurality of specific effective heat transfer coefficients (HTCs) associated with the portable device; repeatedly performing a thermal analysis of the portable device based on the device input file and a current effective HTC to estimate a target die temperature of the semiconductor device; calculating a target effective HTC based on the device input file and the target die temperature; and updating the current effective HTC with the target effective HTC; and generating an output file recording the target die temperature of the semiconductor device.

In another exemplary embodiment, a computer system is provided for performing a method for adaptive thermal resistance-capacitance (RC) network analysis of a semiconductor device for use in a portable device. The computer system comprises: a user interface to a computing device for receiving a device input file and a plurality of specific effective heat transfer coefficients (HTCs) associated with the portable device; and a processor for: repeatedly performing a thermal analysis of the portable device based on the device input file and a current effective HTC to estimate a target die temperature of the semiconductor device; calculating a target effective HTC based on the device input file and the target die temperature; and updating the current effective HTC with the target effective HTC; and generating an output file recording the target die temperature of the semiconductor device.

### BRIEF DESCRIPTION OF THE DRAWINGS

The present invention can be more fully understood by reading the subsequent detailed description and examples with references made to the accompanying drawings, wherein:

FIG. 1 is an isometric view of an exemplary spatial layout of a portable device 100 in accordance with an embodiment of the invention;

FIG. 2 is a diagram of a conventional thermal RC network simulator;

FIG. 3 is a top view of the geometry of the components in the portable device 100 in accordance with an embodiment of the invention;

FIG. 4 is a diagram of an adaptive thermal RC network simulator in accordance with an embodiment of the invention;

FIG. 5 is a diagram illustrating heat transfer inside the portable device 100 in accordance with an embodiment of the invention;

FIG. 6 is a flow chart of a method for adaptive thermal RC network analysis of a semiconductor device for use in a portable device in accordance with an embodiment of the invention;

FIG. 7 is a schematic block diagram of a computer system operable to implement the method for adaptive thermal analysis of a semiconductor device for use in a portable device in FIG. 6; and

FIG. 8 is a diagram of the air flow in a portable device using passive cooling.

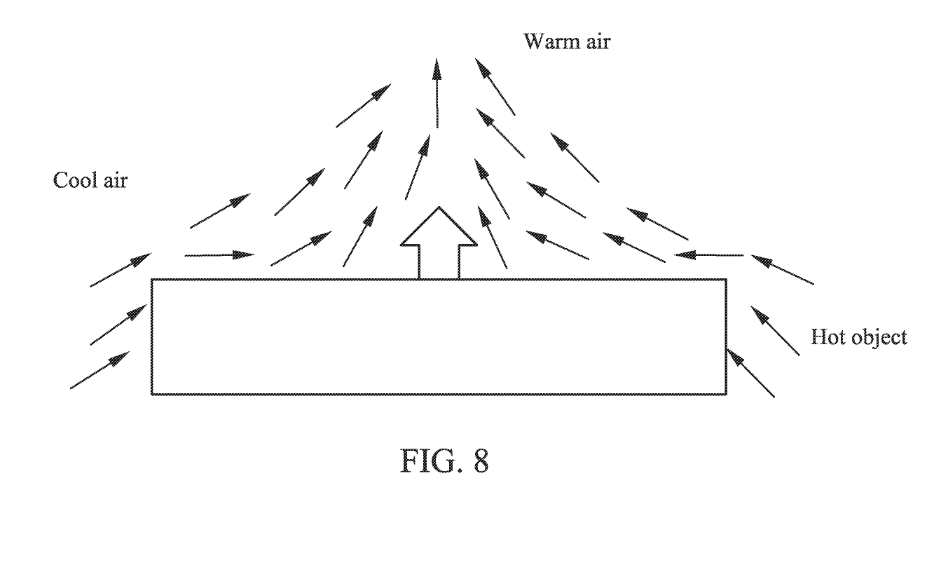

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

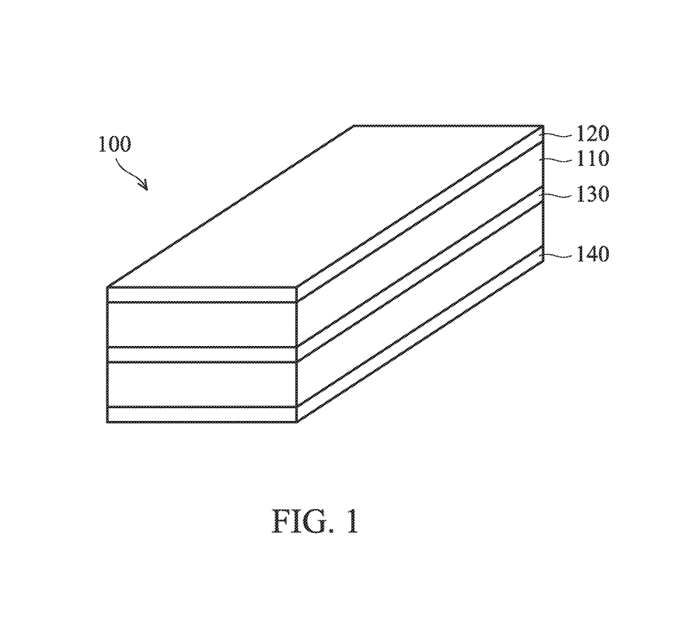

FIG. 1 is an isometric view of an exemplary spatial layout of a portable device 100 in accordance with an embodiment of the invention. Notably, the embodiment of FIG. 1 is not intended to represent a comprehensive layout of the portable device 100, but, rather, is offered for illustrative purposes. In an embodiment, the portable device 100 includes a housing 110, a top layer 120, a middle layer 130, and a bottom layer 140. The top layer 120, the middle layer 130, and the bottom layer 140 are disposed on or inside the housing 110. For example, the top layer 120 may be a liquid-crystal display (LCD) or light-emitting diode (LED) layer which includes an upper cover, an LCD or LED cover, and an LCD or LED screen. The middle layer 130 is a printed circuit board (PCB) sandwiched between the top layer 120 and the bottom layer 140. Various thermal energy producing packages such as, but not limited to, processing cores, modems, power management integrated circuits (PMICs), RF amplifiers, etc. are represented as residing at designated locations either on the top-side or bottom-side of the PCB. One having ordinary skill in the art will recognize that actual layouts within a portable device may include additional PCBs, PCBs with different geometries, additional packages residing on the PCB, packages residing exclusively on one side of the PCB, etc. The bottom layer 140 includes the back cover and supporting inner cases.

For any given portable device 100, the overall dimensions including length, width, and thickness, and the material of the housing 110 are unchangeable after manufacturing. Moreover, one having ordinary skill in the art will recognize that, for any given portable device 100, there may be a limited number of PCB geometries suitable to be housed within the portable device 100. Specifically, the dimensions of the portable device 100, the floorplan or layout of the PCBs and components residing on the PCBs can be integrated into the geometry file.

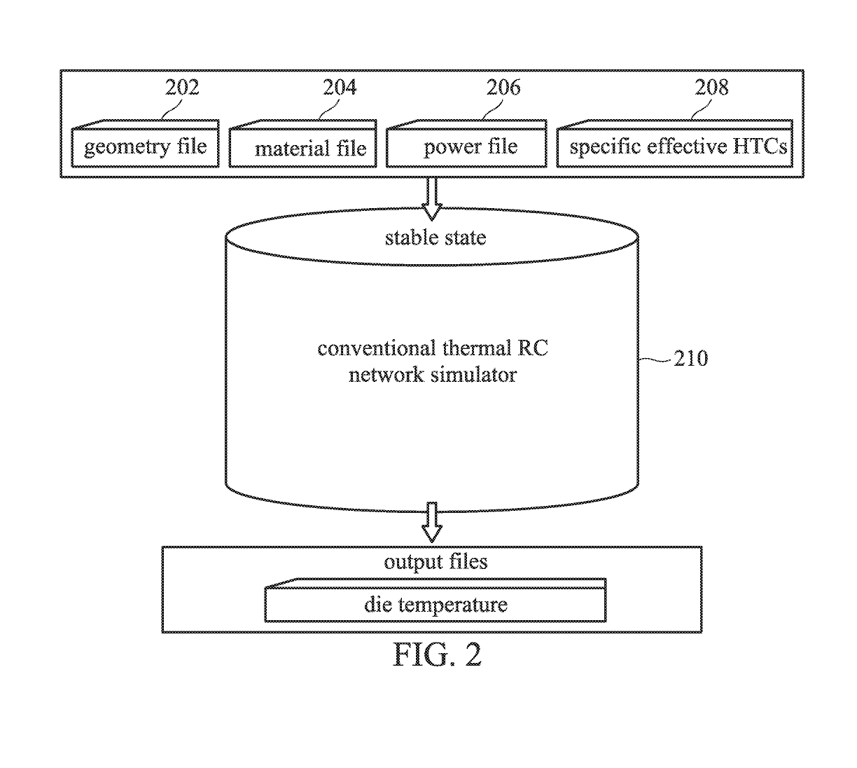

FIG. 2 is a diagram of a conventional thermal RC network simulator. First, a geometry file 202, a material file 204, a power file 206, and specific effective HTCs 208 are input into the conventional thermal RC network simulator 210. For example, the geometry file 202 may record the geometry of the PCB, the dimensions of the portable device 100, the positions of the layers and components within the housing 110, and the air-gap distances between the PCB and other components of the portable device 100. The material file 204 may record the thermal conductivity of the housing 110, and/or the thermal dissipation properties of the portable device 100. The power file 206 may record the power consumption of the components (e.g. SoCs or semiconductor devices) on the PCB. Notably, the semiconductor devices may be integrated circuits (ICs) or system-on-chips (SoCs). The specific effective HTCs 208 may include one or more fixed HTCs. During thermal simulation, a specific HTC is selected from the specific effective HTCs 208 by the conventional thermal RC network simulator 210. Then, the conventional thermal RC network simulator 210 may perform a thermal analysis of the steady state using the selected HTC throughout the simulation process, and then generate output files recording simulated die temperatures of the semiconductor devices on the PCB at each time stamp (e.g. an interval of 1 second) within a given time period (e.g. 30 minutes). Notably, designers of the portable device 100 may select the most appropriate HTC from the specific effective HTCs 208 for thermal analysis. However, when the portable device 100 is changed, the input files 202˜206 may be different from device to device, and thus it is very difficult for the designers to find the most appropriate HTC for thermal analysis, resulting in inaccurate thermal simulation results which may cause the portable device 100 to overheat after being manufactured.

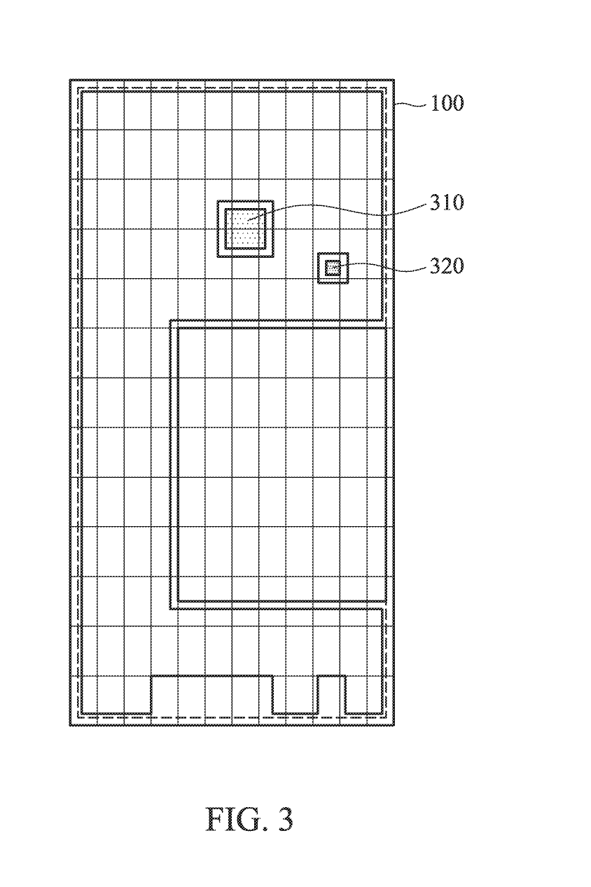

FIG. 3 is a top view of the geometry of the components in the portable device 100 in accordance with an embodiment of the invention. The geometry file may record the dimensions of the portable device 100, and the positions of the layers and components within the housing 110. For example, the housing 110 may have 6 physical surfaces including the top layer 110, the bottom layer 140, and four side surfaces. The locations of the components (e.g. semiconductor devices 310 and 320) within the space of the housing 110 can be defined by coordinates (x, y, z), where x, y, z respectively denote the coordinate in the x-axis (width), y-axis (length), and z-axis (height/thickness). Notably, the HTC is grid-dependent, meaning that the HTC may vary on different physical surfaces. In addition, the HTC is also time-dependent, meaning that the HTC will be dynamically updated over time. Furthermore, different materials may have different heat conductivities, and the HTC also reflects the change of materials. Accordingly, the HTC can be formulated as a function of the location, time, and material, such as HTC=f(x, y, z, t, ε), where t denotes time, and ε denotes the emissivity of the current material of the housing 110.

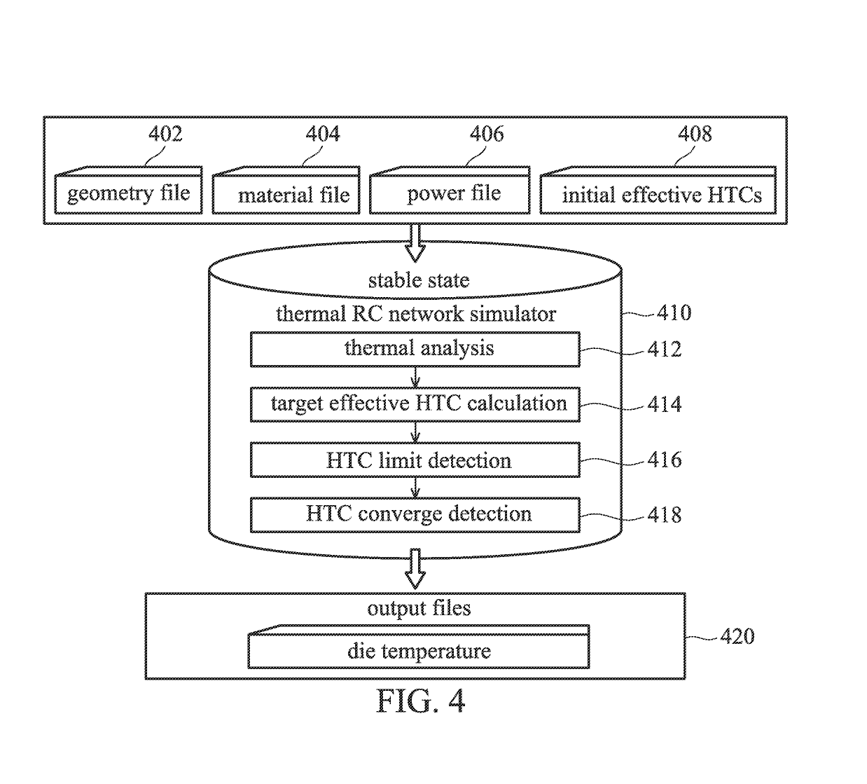

FIG. 4 is a diagram of an adaptive thermal RC network simulator in accordance with an embodiment of the invention. First, a geometry file 402, a material file 404, a power file 406, and initial effective HTCs 408 are input into the adaptive thermal RC network simulator 410. In some embodiments, the geometry file 402, the material file 404, and the power file 406 can be integrated into a device input file. For example, the geometry file 402 may record the geometry of the portable device 100, the dimensions of the portable device 100, the positions of the layers and components within the housing 110, and air-gap distances between the PCB and other components of the portable device 100. The material file 404 may record the thermal conductivity of the housing 110. The power file 406 may record the power consumption of the components (e.g. semiconductor devices) on the PCB. The initial effective HTCs 408 may include one or more candidate initial HTCs, and the adaptive thermal RC network simulator 410 may select one of the initial effective HTCs 408 as the initial HTC for thermal analysis. Then, the adaptive thermal RC network simulator 410 performs a thermal analysis of the portable device 100 in the current loop (block 412), and calculates a target effective HTC based on the current conditions such as the geometry, material, power, and current effective HTC (block 414), where the geometry, material, and power are constant, and the effective HTC is a variable in this embodiment. the target effective HTC calculated by the adaptive thermal RC network simulator 410 may vary when the calculated temperature of the semiconductor devices is changing. In other words, when a higher target temperature of the semiconductor devices is calculated, a higher effective HTC is derived to respond to the change of heat dissipation ability.

In block 416, an HTC limit detection is performed. Specifically, the adaptive thermal RC network simulator 410 determines whether the target effective HTC is within a predetermined range. Specifically, the predetermined range of HTCs is defined based on the physical limitations of the materials and the floorplan of the components in the portable device. When the target effective HTC is not within the predetermined range, it indicates that the target effective HTC is not reasonable due to physical limitations, and then the adaptive thermal RC network simulator 410 may use a check box to prevent the unsuitable effective HTC to enter the iteration loop, and correct the unsuitable target HTC with another appropriate initial HTC.

In block 418, an effective HTC converge detection is performed. Specifically, the adaptive thermal RC network simulator 410 determines whether the effective HTC has converged. For example, the adaptive thermal RC network simulator 410 may calculate the difference between the current effective HTC and the target effective HTC. If the difference is within 1% of the current effective HTC, the adaptive thermal RC network simulator 410 may determine that the effective HTC has converged, that is, heat dissipation of the portable device 100 is in a stable state using the current effective HTC. If the difference exceeds 1% of the current effective HTC, the adaptive thermal RC network simulator 410 may determine that the effective HTC is not converged. When it is determined that the effective HTC is converged, the adaptive thermal RC network simulator 410 adds the estimated die temperature of the current iteration into the output file 420. When it is determined that the effective HTC is not converged, the adaptive thermal RC network simulator 410 updates the effective HTC with the target effective HTC, and performs the iteration in blocks 412 and 414.

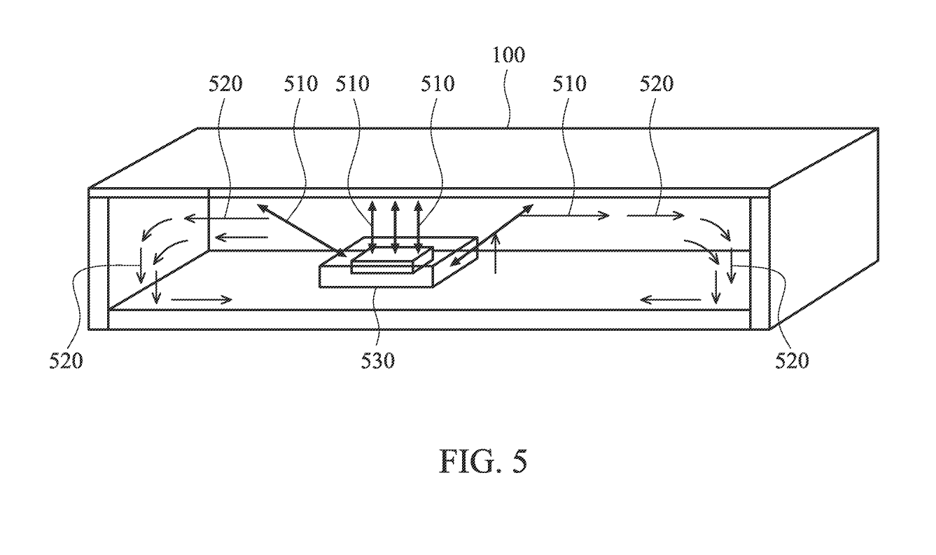

FIG. 5 is a diagram illustrating heat transfer inside the portable device 100 in accordance with an embodiment of the invention. Referring to FIG. 4 and FIG. 5, the heat transfer inside the portable device 100 is shown in FIG. 5, where the arrows 510 indicate heat radiation from the semiconductor device 530, and arrows 520 indicate the convection flow. The thermal RC network simulator 410 uses a simplified heat transfer algorithm to estimate the die temperature of the semiconductor devices 510 in the portable device 100. For example, the thermal RC network simulator 410 uses an “effective air thermal conductivity” to encompass all heat transfer mechanisms inside the portable device 100. In addition, the effective air thermal conductivity can be applicable for a general portable device, and the simulation result of the thermal RC network simulator proposed in the disclosure can be kept accurate when applied to a different portable device.

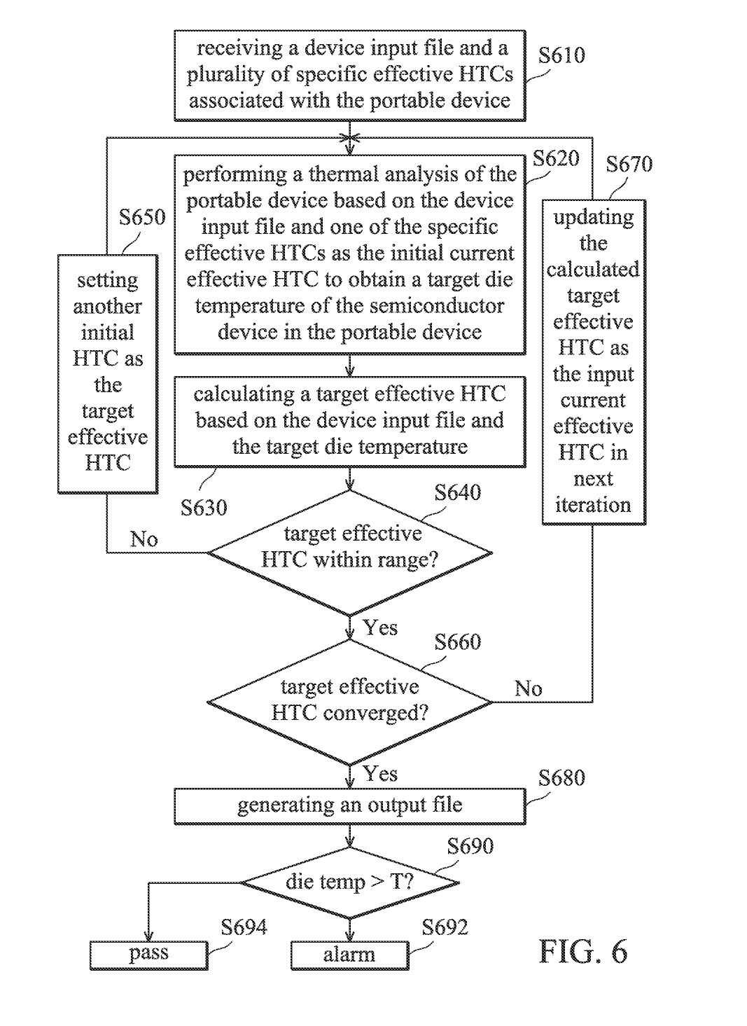

FIG. 6 is a flow chart of a method for adaptive thermal RC network analysis of a semiconductor device for use in a portable device in accordance with an embodiment of the invention. In step S610, a device input file and a plurality of specific effective HTCs associated with the portable device are received. Notably, the device input file may include all details of the portable device 100, such as a geometry file, a material file, and a power file. For example, the geometry file may include, but is not limited to, length, width, and thickness of the overall portable device 100, air-gap distances between the PCB and other components of the portable device 100, the floor plan of the layers and components in the portable device 100, etc. The material file may include the thermal dissipation properties of the housing 110 and the layers 120˜140 of the portable device 100. The power file may specify the power consumption of each component in the portable device 100. In step S620, thermal analysis of the portable device is performed based on the device input file and one of the specific effective HTCs as the initial current effective HTC to obtain a target die temperature of the semiconductor device in the portable device 100. In step S630, a target effective HTC is calculated based on the device input file and the target die temperature. It should be noted that an initial effective HTC is selected from the plurality of specific effective HTCs as the current effective HTC when the iteration loop is performed for the first time. In step S640, it is determined whether the calculated target effective HTC is reasonable (i.e. within a predetermined range). If the calculated target effective HTC is reasonable, step S660 is performed. If the calculated target effective HTC is not reasonable, step S650 is performed.

In step S650, another appropriate initial HTC is set as the target effective HTC, and a new iteration for thermal analysis is performed. Notably, steps S640 and S650 can be omitted in some embodiments. In step S660, it is determined whether the target effective HTC is converged. For example, the difference between the current effective HTC and the target effective HTC is calculated. If the difference is within a predetermined portion (e.g. 1%) of the current effective HTC, it is determined that the target effective HTC is converged, that is, heat dissipation of the portable device 100 is in a stable state using the current effective HTC, and then step S680 is performed. If the difference exceeds 1% of the current effective HTC, it is determined that the target effective HTC is not converged, and then step S670 is performed. In step S670, the calculated target effective HTC is updated as the input current effective HTC in next iteration. In step S680, an output file recording the calculated die temperature of the portable device is generated.

In step S690, it is determined whether the calculated die temperature is higher than a predetermined temperature T (i.e. overheat detection). When the calculate die temperature is higher than the predetermined temperature, an alarm signal is generated (step S692), and thus designers can be informed that the current design of the portable device may have an overheat issue. When the calculate die temperature is not higher than the predetermined temperature, the result of thermal simulation denotes “PASS” (step S694), and thus designers may be more confident to use current design of the portable device.

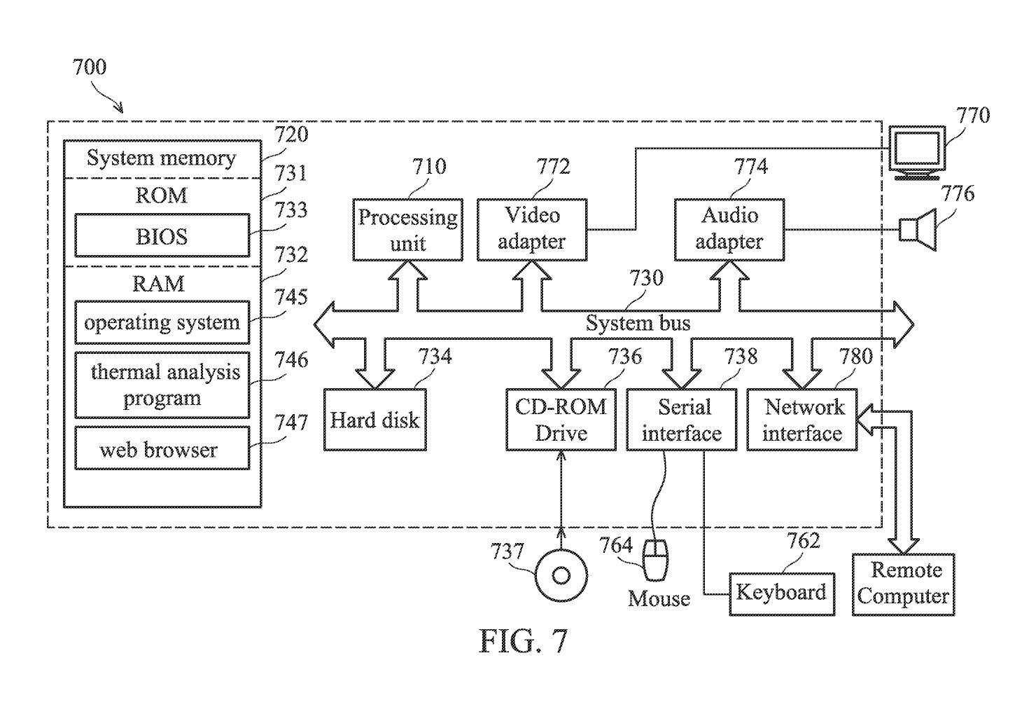

FIG. 7 is a schematic block diagram of a computer system operable to implement the method for adaptive thermal analysis of a semiconductor device for use in a portable device in FIG. 6. In an embodiment, the computer system 700 includes a processing unit 710, a system memory 720, and a system bus 730 that couples various system components including the system memory 720 to the processing unit 710.

The system bus 730 may be any of several types of bus structures including a memory bus or memory controller, a peripheral bus, and a local bus using any of a variety of bus architectures. The system memory includes a read-only memory (ROM) 731 and a random access memory (RAM) 732. A basic input/output system (BIOS) 733, containing the basic routines that help to transfer information between elements within the computer system 700, such as during start-up, is stored in ROM 731.

A number of program modules may be stored on hard disk 734, memory card 735, optical disk 736, ROM 731, or RAM 732 including an operating system 745, a thermal analysis program 746, and a web browser 747. The thermal analysis program 746 Program modules include routines, sub-routines, programs, objects, components, data structures, etc., which perform particular tasks or implement particular abstract data types. Aspects of the methods may be implemented in the form of a thermal analysis program 746 which is executed by the central processing unit 710 of the computer system 700 in order to generate records of the estimated die temperature at each time stamp.

For the purpose of data input and package location on a PCB, it is envisioned that some embodiments may employ a form-based user interface while others may use a visual-based user interface. The user interface may be provided through a personal computer (“PC”) based application, a web based application (e.g. via web browser 747), a mobile device app or otherwise. User interfaces may be of a graphical user interface (GUI) type as is known to those skilled in the art.

A user may enter commands and information into computer system 700 through input devices, such as a keyboard 762, a pointing device 764 (e.g. a mouse), or other input means. The display 770 may also be connected to system bus 730 via an interface, such as a video adapter 772. The display 770 can comprise any type of display devices such as a liquid-crystal display (LCD), a plasma display, an organic light-emitting diode (OLED) display, and a cathode ray tube (CRT) display. The audio adapter 774 interfaces to and drives another alert element 776, such as a speaker or speaker system, buzzer, bell, etc.

A network interface 780 is also coupled to the system bus 730, and the computer system 700 may establish communication with other computer systems through the network interface, so that the user may control the computer system 700 to receive the device input file from other computer systems on the network or from the local storage devices via the user interface shown ion the display 770.

Moreover, those skilled in the art will appreciate that the present invention may be implemented in other computer system configurations, including hand-held devices, multiprocessor systems, microprocessor based or programmable consumer electronics, network personal computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for adaptive thermal resistance-capacitance (RC) network analysis of a semiconductor device for use in a portable device, comprising:
receiving a device input file and a plurality of specific effective heat transfer coefficients (HTCs) associated with the portable device;
repeatedly performing a thermal analysis of the portable device based on the device input file and a current effective HTC to estimate a target die temperature of the semiconductor device;
calculating a target effective HTC based on the device input file and the target die temperature; and
updating the current effective HTC with the target effective HTC; and
generating an output file recording the target die temperature of the semiconductor device.

2. The method as claimed in claim 1, wherein the device input file comprises a geometry file, a material file, and a power file of the portable device.

3. The method as claimed in claim 2, wherein the geometry file comprises geometry of the portable device, a floorplan of components of the portable device, and dimensions of the portable device.

4. The method as claimed in claim 1, wherein one of the effective HTCs is selected as the current effective HTC when the thermal analysis is performed for the first time.

5. The method as claimed in claim 1, wherein after calculating the target effective HTC, the method further comprises:
determining whether the estimated effective HTC is within a predetermined range; and
selecting another appropriate one from the plurality of specific effective HTCs as the current effective HTC when the calculated target effective HTC is not within the predetermined range.

6. The method as claimed in claim 5, further comprising:
determining whether the target effective HTC is converged when the estimated effective HTC is within the predetermined range; and
updating the current effective HTC with the target effective HTC when the target effective HTC is not converged.

7. The method as claimed in claim 6, wherein the step of determining whether the target effective HTC is converged when the estimated effective HTC is within the predetermined range further comprises:
calculating a difference between the current effective HTC and the calculated target effective HTC;
determining whether the difference is smaller than a predetermined portion of the current effective HTC;
if so, determining that the target effective HTC is converged; and
otherwise, determining that the target effective HTC is not converged;

8. The method as claimed in claim 1, further comprising:
calculating an effective air thermal conductivity of the inner space of the portable device for the thermal analysis.

9. The method as claimed in claim 8, wherein the target effective HTC is expressed as HTC=f(x, y, z, t, ε), wherein x, y, z denote coordinates of the semiconductor device in the portable device; t denotes time; and ε denotes emissivity of a material of a housing of the portable device.

10. The method as claimed in claim 1, further comprising:
determining whether the target die temperature is higher than a predetermined temperature; and
generating an alarm signal when the target die temperature is higher than the predetermined temperature.

11. A computer system for performing a method for adaptive thermal resistance-capacitance (RC) network analysis of a semiconductor device for use in a portable device, the computer system comprising:
a user interface to a computing device for receiving a device input file and a plurality of specific effective heat transfer coefficients (HTCs) associated with the portable device; and
a processor for:
repeatedly performing a thermal analysis of the portable device based on the device input file and a current effective HTC to estimate a target die temperature of the semiconductor device;
calculating a target effective HTC based on the device input file and the target die temperature; and
updating the current effective HTC with the target effective HTC; and
generating an output file recording the target die temperature of the semiconductor device.

12. The computer system as claimed in claim 11, wherein the device input file comprises a geometry file, a material file, and a power file of the portable device.

13. The computer system as claimed in claim 12, wherein the geometry file comprises geometry of the portable device, a floorplan of components in the portable device, and dimensions of the portable device.

14. The computer system as claimed in claim 11, wherein one of the effective HTCs is selected as the current effective HTC when the thermal analysis is performed for the first time.

15. The computer system as claimed in claim 11, wherein after calculating the target effective HTC, the processor further determines whether the estimated effective HTC is within a predetermined range, and selects another appropriate one from the plurality of specific effective HTCs as the current effective HTC when the calculated target effective HTC is not within the predetermined range.

16. The computer system as claimed in claim 15, wherein the processor further determines whether the target effective HTC is converged when the estimated effective HTC is within the predetermined range, and updates the current effective HTC with the target effective HTC when the target effective HTC is not converged.

17. The computer system as claimed in claim 16, wherein when the processor determines whether the target effective HTC is converged, the processor further calculates a difference between the current effective HTC and the calculated target effective HTC, and determines whether the difference is smaller than a predetermined portion of the current effective HTC;
if so, the processor determines that the target effective HTC is converged; and
otherwise, the processor determines that the target effective HTC is not converged.

18. The computer system as claimed in claim 11, wherein the processor further calculates an effective air thermal conductivity of the inner space of the portable device for the thermal analysis.

19. The computer system as claimed in claim 18, wherein the target effective HTC is expressed as HTC=f(x, y, z, t, ε), wherein x, y, z denote coordinates of the semiconductor device in the portable device; t denotes time; and ε denotes emissivity of a material of a housing of the portable device.

20. The computer system as claimed in claim 11, wherein the processor further determines whether the target die temperature is higher than a predetermined temperature, and generates an alarm signal when the target die temperature is higher than the predetermined temperature.
